(19) United States
(12) Patent Application Publication
(10) Pub. No.: US 2024/0139894 A1
(43) Pub. Date: May 2, 2024

(54) Safety Gate Monitoring Module

(71) Applicant: Pilz GmbH & Co. KG, Ostfildern (DE)

(72) Inventors: Sven Bauer, Ostfildern (DE); Joachim Rink, Ostfildern (DE); Andreas Veit, Ostfildern (DE)

(21) Appl. No.: 18/496,915

(22) Filed: Oct. 29, 2023

(30) Foreign Application Priority Data
Oct. 28, 2022 (DE) 10 2022 128 727

(51) Int. Cl. B23Q 11/08; F16P 3/08

(52) U.S. Cl. CPC B23Q 11/0891; F16P 3/08

(57) ABSTRACT

A safety gate monitoring module is configured to monitor a state of a safety gate. A base device includes an actuator receptacle configured to receive an actuator and generates the safety gate signal in response to the actuator being inserted into the actuator receptacle. The base device includes a first interface, an axis, and a first end face arranged transversely to the axis. A mounting bracket includes a second interface configured to be coupled to the first interface of the base device in a first position, a second position rotated clockwise by 90° with respect to the first position, and a third position rotated clockwise by 90° with respect to the second position. The first and second interfaces include a mechanical blocking device that prevents coupling of the first and second interfaces in a fourth position rotated clockwise by 90° with respect to the third position.

### CROSS-REFERENCE TO RELATED APPLICATIONS

This application claims priority to German patent application DE 10 2022 128 727, filed on Oct. 28, 2022. The entire content of this priority application is incorporated herein by reference.

### FIELD

The present disclosure relates to a safety gate monitoring module having a base device for monitoring a state of a safety gate.

### BACKGROUND

Safety gate monitoring modules of the abovementioned type are often also referred to as safety switches. Example safety gate monitoring modules or safety switches are disclosed in DE 10 2005 057 108 A1, DE 103 05 704 B3, DE 10 2008 060 004 A1 and DE 10 2020 120 817 A1.

Safety gate monitoring modules are usually used on safety gates, safety flaps and the like. Although the terms “safety gate monitoring module” and “safety gate” are used in the present case, the safety gate monitoring module according to the invention can be used on any type of separating protective device. The term “safety gate” in the present sense should accordingly be interpreted broadly. Instead of the general term “separating protective device”, only the term “safety gate” is therefore used below, without this being intended to restrict the scope of protection.

Safety gates on which the safety gate monitoring module according to the disclosure can be used, for example, typically serve as an access to a safety area in which an automatically operating machine or system is located. The machine can be, for example, a robot, a machine tool with a fast-rotating spindle, a transport or conveying system, a press or some other machine or system whose operation poses a risk to persons who are in the aforementioned safety area or in the working area of the machine. The safety gate monitoring module can serve as a signalling device, with the aid of which a control unit can detect the closed state of the safety gate. The control unit is configured to read out the safety gate signal generated by the safety gate monitoring module and to control the machine in accordance with the safety gate signal. For example, the machine can only be operated if the safety gate signal is present. In other words, the control unit is configured to allow operation of the machine or system only if it receives the safety gate signal from the safety gate monitoring module, i.e. if the safety gate is closed. If, on the other hand, the safety gate is opened during operation (if possible), the control unit must bring the machine or system into a safe state in which, for example, the power supply to the machine or system is switched off.

There are a large number of machines and systems that still pose a risk for a certain period of time even after they have been switched off, for example because the machine or system is still running down. For such applications, there is a need for safety gate monitoring modules which prevent the safety gate from opening until the machine or system has reached its safe state. This function is referred to as a guard lock function.

Traditionally, safety gate monitoring modules of the present type have what is referred to as an actuator and an actuator receptacle functioning as a counterpart thereto. The actuator receptacle is part of a base device, in which further electronic components are typically accommodated and from which the connecting cables that connect the safety gate monitoring module to the control unit usually originate. Accordingly, the base device with the actuator receptacle may be arranged on an immovable part of the safety gate (e.g. on a door frame), while the actuator may be arranged on a movable part of the safety gate (e.g. on a movable door leaf). This has an advantage that the part of the safety gate monitoring module that is arranged on the movable part of the safety gate does not need to be supplied with power since, as a rule, only the base device of the safety gate monitoring module has to be supplied with power.

When the safety gate is closed, the actuator engages in the actuator receptacle, this being detected with the aid of one or more sensors. In the case of a safety gate monitoring module with a guard lock system, the actuator is also blocked or locked in the actuator receptacle against retraction. The “guard lock system” therefore may include a locking device for locking the actuator in the actuator receptacle.

In the latter case, the safety gate monitoring module thus performs two functions, namely on the one hand a detection function, with the aid of which the closed position of the safety gate is detected, and on the other hand a guard lock function, which prevents the safety gate from opening as long as the actuator is locked in the actuator receptacle. The actuator can be released, for example, by means of an electric-motor actuator, which is actuated by the control unit as soon as the monitored machine or system has assumed its safe state.

A safety gate monitoring module of this type is marketed by the applicant under the name PSENmlock. This safety gate monitoring module works flawlessly and is versatile. If the actuator of the safety gate monitoring module is substantially rod-shaped or pin-shaped and the actuator receptacle functioning as a counterpart thereto is configured as a through groove, as a U-shaped opening, or as a blind hole or through-hole, into which the rod-shaped or pin-shaped actuator is inserted, this type of configuration results in a relatively high potential for injury since the actuator, in particular, poses a high risk of injury on account of its shape. On the other hand, the actuator and the actuator receptacle must be aligned relatively exactly with respect to one another since otherwise the rod-shaped or pin-shaped actuator does not exactly match the position of the associated through groove, the associated U-shaped opening, the associated blind hole or the associated through-hole and thus cannot be inserted therein.

DE 10 2020 120 817 A1 describes a safety gate monitoring module which, by virtue of an annular actuator element, offers increased flexibility with regard to different installation situations in comparison with a rod-shaped or pin-shaped actuator.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Depending on the installation situation, the position and alignment of the actuator must be adjusted relative to the actuator receptacle for the aforementioned reasons. The installation situation can be characterized, for example, by the type of safety gate (e.g. pivoting safety gate or sliding safety gate), by the spatial alignment of the immovable part of the safety gate and the movable part of the safety gate relative to one another and/or by the available installation space on the movable or immovable part of the safety gate, etc.

In addition, there is the possibility of incorrect assembly, in which a user installs the safety gate monitoring module in such a way that, while being in the same spatial position, the actuator and actuator receptacle are aligned with respect to one another spatially in such a way that the actuator cannot be inserted into the actuator receptacle.

The present disclosure relates to a safety gate having a safety gate monitoring module of the abovementioned type, wherein the base device is arranged on a first part of the safety gate, and an actuator is arranged on a second part of the safety gate, wherein the first part and the second part of the safety gate are separated from one another when the safety gate is opened.

According to a further aspect, the present disclosure relates to a safety gate monitoring system having a safety gate as an access to a safety area, a safety gate monitoring module of the type mentioned above, and a control unit, which is configured to read out the safety gate signal and to control a machine or system located in the safety area in accordance with the safety gate signal.

It is an object to provide a safety gate monitoring module which can be handled easily and flexibly by a user in relation to different installation situations and prevents incorrect assembly.

The safety gate monitoring module includes a base device including an actuator receptacle and a mounting bracket that is configured to be coupled to an interface of the base device in a first position, a second position rotated clockwise by 90° with respect to the first position about the axis of the base device, and a third position rotated clockwise by 90° with respect to the second position about the axis of the base device, wherein the mounting bracket and the base device include a mechanical blocking device that is configured to prevent coupling of the mounting bracket to the interface of the base device in a fourth position rotated clockwise by 90° with respect to the third position about the axis of the base device.

An advantage of the present disclosure is that a user (e.g. a fitter) can easily and flexibly assemble the safety gate monitoring module in various installation situations. With the aid of the mounting bracket, one and the same base device can be aligned and fixed/fastened in different spatial orientations with respect to a mounting surface on a safety gate, depending on the existing installation situation. For example, in a first position, a second position, or a third position, the mounting bracket is coupled to the base device and attached to a mounting surface or safety gate (e.g. a door frame), enabling the actuator receptacle to receive the actuator.

At the same time, incorrect assembly of the base device with respect to an alignment of the base device that is not suitable for reception of the actuator is advantageously avoided by virtue of the fact that the mounting bracket can be fixed or fastened on the base device only in the predefined positions and thus the base device too can be fixed or fastened on a safety gate only in predefined alignments relative to a mounting surface or on a safety gate. An unfavourable alignment of the safety gate monitoring module relative to a mounting surface, in which the actuator cannot or can only with difficulty engage in the actuator receptacle, is avoided by the base device and the mounting bracket having a mechanical blocking device. The mechanical blocking device prevents the mounting bracket from being able to be coupled to the base device in the fourth position.

According to a refinement, the mounting bracket includes a mounting side that is arranged transversely to the second interface of the mounting bracket, wherein the actuator receptacle is configured to receive an actuator from a first direction, from a second direction rotated anticlockwise by 90° with respect to the first direction about the axis of the base device, and from a third direction rotated anticlockwise by 90° with respect to the second direction about the axis of the base device, and wherein the mounting side is orthogonal to the first direction in the first position, the mounting side is orthogonal to the second direction in the second position, and the mounting side is orthogonal to the third direction in the third position.

In other words, the actuator receptacle of the base device is configured to receive the actuator from three different directions, wherein the first direction, the second direction and the third direction are rotated successively by 90° about the longitudinal axis of the base device with respect to one another in an anticlockwise direction. When the mounting bracket is in the first position or in the third position, the first direction in which the actuator can be received is in each case orthogonal to the mounting side. If, on the other hand, the mounting bracket is in the second position, the second direction in which the actuator can be received is orthogonal to the mounting side.

For mounting the safety gate monitoring module on a safety gate or mounting surface, the mounting side of the mounting bracket can be aligned parallel to the safety gate or the mounting surface.

The mounting bracket may have a substantially L-shaped cross section.

According to a further refinement, the mechanical blocking device includes a mechanical blocking element and a recess, wherein one of the two interfaces includes the mechanical blocking element and the other one of the two interfaces includes the recess that is configured to receive the mechanical blocking element in the first position, the second position, and the third position, respectively, and to prevent the fourth position.

In other words, the recess and the mechanical blocking element interact in a manner similar to a slot and a key. In the fourth position, the mechanical blocking element cannot engage in the recess, and thus coupling of the base device to the mounting bracket in the fourth position is prevented. In contrast, the mechanical blocking element can engage in the recess in the first position, in the second position, and in the third position, respectively.

It is self-evident that the mounting bracket can only be coupled to the base device in one position at a time. In other words, the mounting bracket cannot be coupled to the base device in two positions at the same time.

The mechanical blocking device has an advantage that coupling of the mounting bracket to the base device in the fourth position is avoided. The fourth position is an unsuitable position. An unsuitable position refers to an orientation of the mounting bracket with respect to the base device in which the base device is oriented in such a way in the mounted state on a safety gate or a mounting surface that an actuator cannot engage in the actuator receptacle or can do so only with difficulty.

The mechanical blocking device therefore acts as an incorrect assembly safeguard. This has a positive effect on the process of mounting the safety gate monitoring module on a safety gate or a mounting surface since the user is relieved of the burden of considerations connected with assembly, and time-consuming conversion work that follows incorrect assembly is avoided.

For example, the one interface can have three spatially separate recesses, each of which is configured to receive the mechanical blocking element in a specific position of the mounting bracket. In other words, according to this example, a first recess is configured to receive the mechanical blocking element in the first position, a second recess is configured to receive the mechanical blocking element in the second position, and a third recess is configured to receive the mechanical blocking element in the third position. Since the mechanical blocking element cannot be received in the fourth position, the mounting bracket cannot be coupled to the base device in the fourth position.

In a refinement, the mounting bracket includes the mechanical blocking element and the base device includes the corresponding recess. It is equally possible that the base device includes the mechanical blocking element and the mounting bracket includes the recess.

According to a further refinement, the recess is a recess that extends around the axis of the base device by less than 360°.

Compared to the abovementioned example with recesses spatially separated from one another, the recess extending around less than 360° has an advantage that the mounting bracket can be rotated (in an infinitely variable manner) from the first position into the second position and/or from the second position into the third position, for example, without the mounting bracket having to be moved axially parallel to the axis of the base device. This has an effect that the user can mount the safety gate monitoring module easily and conveniently.

Another advantage of the recess extending around less than 360° is that the mounting bracket cannot perform multiple complete rotations about the axis of the base device without axial movement in a direction parallel to the axis of the base device. This is also advantageous particularly if the safety gate monitoring module includes a plug. If the plug is connected to the base device via electrical connections, these electrical connections, such as strands or cables, should be protected from being twisted multiple times. Otherwise, the electrical connections could be damaged or could even tear off.

The recess may have an angular range greater than 180°.

According to a further refinement, the base device and/or the mounting bracket include a first axial locking that axially locks the mounting bracket along the axis of the base device.

This has an advantage that a user does not have to lock or secure the mounting bracket axially by hand during assembly. This has a simplifying effect on the assembly process. In particular, a user can rotate the mounting bracket from one position to another position without locking or securing the mounting bracket axially by hand in a direction parallel to the axis of the base device, for example from the first position to the second position and/or from the second position to the third position.

According to a further refinement, the base device includes a detachably fixed side wall that includes a part of the first axial locking.

In other words, the base device includes a side wall that can be detached from and reattached to the base device, and at least a part of the first axial locking is arranged on this side wall.

This configuration has an advantage, in particular, that the first axial locking can only be detached when the detachably fixed side wall is detached from the base device. This can have a positive effect on the assembly process since a user automatically uses or “holds” the mounting bracket and the base device together, and therefore cannot “lose” the mounting bracket, for example.

Furthermore, unwanted access to the base device via the first interface can be limited by only authorized users being able to detach or fasten the detachably fixed side wall of the base device or by unauthorized access being optically detectable. For example, one or more screws that fasten or fix the detachably fixed side wall to the base device can be secured with locking compound.

According to a further refinement, the mounting bracket includes a mounting side that is arranged transversely to the second interface of the mounting bracket, wherein the base device includes a first through-hole and a second through-hole, the second through-hole extending orthogonally to the first through-hole, and wherein the first through-hole extends orthogonally to the mounting side in the first position and the third position, and the second through-hole extends orthogonally to the mounting side in the second position.

In other words, a longitudinal axis of the first through-hole extends orthogonally to the mounting side of the mounting bracket when the mounting bracket is coupled to the base device in the first position. The longitudinal axis of a through-hole refers to the axis along which the through-hole extends or along which the through-hole was made (e.g. drilled) or along which a fixing device can be received. When the mounting bracket is coupled to the base device in the second position, a longitudinal axis of the second through-hole extends orthogonally to the mounting side. When the mounting bracket is coupled to the base device in the third position, the longitudinal axis of the first through-hole again extends orthogonally to the mounting side.

The first through-hole and the second through-hole are each configured to receive a fixing device. Therefore, the safety gate monitoring module can be attached to the safety gate or mounting surface, respectively, by means of a fixing device received by either the first through-hole or the second through-hole. This has an advantage that the safety gate monitoring module has a further fixing point on either the safety gate or the mounting surface—in addition to the fixing point on the mounting side of the mounting bracket. It is thereby possible to improve the mechanical stability of the connection of the base device to the mounting surface or safety gate. The fixing device may include a screw.

According to a further refinement, the mounting bracket includes a mounting side that is arranged transversely to the second interface of the mounting bracket, wherein the base device includes a first side surface, a second side surface and a third side surface that are arranged substantially transversely to the first end face, and wherein the mounting side of the mounting bracket is flush with or parallel to the first side surface in the first position, is flush with or parallel to the second side surface in the second position, and is flush with or parallel to the third side surface in the third position.

This configuration has an advantage, in particular, that in the first position, the second position, and the third position, one of the side surfaces of the base device is parallel to the mounting side of the mounting bracket or is aligned with it in each case. When the mounting side is connected to a safety gate or a mounting surface, one of the side surfaces of the base device is also parallel to the safety gate or mounting surface or is aligned with it. If the base device rests against the safety gate or mounting surface, this can have a positive effect on the mechanical stability of the safety gate monitoring module.

In the present case, the term “transverse” does not necessarily mean perpendicular or orthogonal. Instead, “transverse” includes an alignment at any angle (including 90°) except a parallel alignment.

According to a further refinement, the first interface includes a plug that is configured to transmit current and/or electrical signals, and wherein the second interface includes a first receptacle configured to receive the plug.

The plug can be used to supply the base device with power, for example. Likewise, control signals, for example, can be transmitted between the safety gate monitoring module and a control unit.

The arrangement of the plug on the first interface has an advantage, in particular, that the plug is accessible in the first position, the second position, and the third position, respectively. Accessible means that the plug or the first interface is not covered by the safety gate or mounting surface. In addition, the mounting bracket can also advantageously function as a plug holder at the same time. However, it is conceivable for the plug to be connected to the base device at some other point.

According to a further refinement, the plug and/or the mounting bracket include an anti-rotation lock that is configured to rotationally lock or secure the plug with respect to the axis of the base device in the first receptacle.

The anti-rotation lock has an advantage, in particular, that one or more electrical connections, such as cables, which can electrically connect the plug to the base device, are held in one position and cannot be twisted about the axis of the base device owing to an unwanted rotation of the plug. For example, in a state of the safety gate monitoring module (and in particular of the mounting bracket) mounted on a safety gate or mounting surface, electrical connections could be damaged by multiple rotation of the plug. The anti-rotation lock therefore has a positive effect on the safety and reliability of the safety gate monitoring module.

On the other hand, the anti-rotation lock causes the plug to rotate with the mounting bracket when the mounting bracket is rotated from one position to another position. In other words, the alignment of the plug with respect to the mounting bracket is fixed in the direction of rotation about the axis of the base device. This is the case, for example, even when the mounting bracket is rotated from the first position to the third position via the second position.

The first receptacle of the mounting bracket may include an inner contour and the plug includes an outer contour corresponding thereto, wherein the inner contour and the outer contour secure the plug rotationally in the first receptacle in relation to the axis of the base device.

The plug may include a plug head with an outer contour, and the first receptacle of the mounting bracket may include an inner contour corresponding thereto, thus preventing rotation of the plug about the longitudinal axis of the base device.

The anti-rotation lock advantageously also includes a positioning device that allows the plug to be received in the first receptacle of the mounting bracket in only one specific position.

This has an effect that the plug is always aligned in the same way relative to the mounting bracket, in particular in the first position, the second position and the third position. When the plug is connected to a connection plug, this refinement has an advantage, in particular, that the connection plug too can always be arranged in the same orientation relative to the mounting bracket. This is advantageous also particularly if the connection plug can only be connected to the plug in a specific alignment with respect to the plug. This is also advantageous if the connection plug has a certain spatial requirement and can or should only be aligned in certain orientations relative to the safety gate or the mounting surface.

For example, the plug is substantially cylindrical and includes a flattened cylinder lateral surface, wherein the first receptacle of the mounting bracket includes an inner contour corresponding thereto.

According to a further refinement, the plug and/or the mounting bracket include a second axial locking that axially locks the plug in the first receptacle along the axis of the base device.

The plug may include a body with a head, wherein the first receptacle receives the body of the plug, and the head of the plug latches along the axis of the base device with a latching element of the mounting bracket.

The second axial locking may include a thread and a nut. For example, the plug has a cylindrical shape with a thread, wherein a nut is screwed onto the thread and fastens the plug on the mounting bracket axially along the axis of the base device.

According to a further refinement, the first interface includes a plurality of second receptacles and the second interface includes a plurality of third receptacles, wherein in each case at least one of the plurality of third receptacles is aligned with one of the plurality of second receptacles of the first interface in the first position, the second position and the third position, and wherein the multiplicity of second receptacles and the multiplicity of third receptacles are each configured to receive a fixing device for coupling the first interface to the second interface.

This refinement has an advantage of a positioning aid for the user. This means that the user is assisted in aligning the mounting bracket in the first position, the second position and the third position, respectively, relative to the base device. This can have a positive effect on the assembly process by indicating the suitable positions to the user in a simplified manner and thus relieving the burden on the user as regards considerations relating to assembly.

Particularly in the case of a refinement with a recess extending by less than 360° around the axis of the base device, an infinitely variable transition between the first position, the second position, and the third position is possible. Particularly in the case of this refinement, mutually aligned second receptacles and third receptacles can indicate the first position, the second position and the third position to the user.

In a refinement, the first interface includes four second receptacles and the second interface includes four third receptacles, wherein the second receptacles and the third receptacles are arranged on corner points of a square.

The fixing device may include a screw. For example, the mounting bracket is fastened on the base device using four screws, wherein the first interface includes four second receptacles and the second interface includes four third receptacles, wherein a second receptacle and a corresponding third receptacle each receive a screw. In other words, the longitudinal axes of the four screws each extend parallel to a longitudinal axis of a second receptacle and a third receptacle which, depending on the position, corresponds thereto. It is self-evident that this applies to the first position, the second position, and the third position, wherein the mounting bracket can be in only one position at a time.

According to a further refinement, the mounting bracket includes a mounting side that is arranged transversely to the second interface of the mounting bracket, and the mounting side of the mounting bracket includes a fourth receptacle that is configured to receive a fixing device for fastening the mounting bracket to a mounting surface.

The fixing device may include a screw, by means of which the mounting side of the mounting bracket can be fastened on a safety gate or on a mounting surface.

According to a further refinement, the plug includes a poka-yoke element.

The poka-yoke element has an advantage that a connection plug can be connected to the plug only in a certain alignment relative to the plug. This has a positive effect on the assembly process since incorrect assembly can be prevented in this way. Another advantage is that the poka-yoke element can prevent the connection of a connection plug which is not suitable for connection to the safety gate monitoring module.

As already mentioned at the outset, another aspect of the present disclosure relates to a safety gate on which a safety gate monitoring module according to the disclosure is mounted. The design options mentioned above and defined in the dependent claims also apply equivalently to the safety gate having the safety gate monitoring module according to the disclosure.

The safety gate may include a first part, on which the base device of the safety gate monitoring module is arranged, and a second part, on which the actuator of the safety gate monitoring module is arranged. The two parts of the safety gate are separated from one another when the safety gate is opened. The actuator is therefore situated in the actuator receptacle of the base device only in the closed state of the safety gate.

The first part of the safety gate, on which the base device is arranged, may be a stationary part of the safety gate (e.g. a door frame or a door case). Equivalently to this, the second part of the safety gate, on which the actuator is arranged, may be a movable door element (e.g. a door leaf). The arrangement of the base device on the stationary part of the safety gate has an advantage that a power supply of the part of the safety gate monitoring module mounted on the movable part of the safety gate can be omitted since typically only the base device of the safety gate monitoring module has to be supplied with power.

As also already mentioned at the outset, a further aspect of the present disclosure relates to a safety gate monitoring system which includes a safety gate of the abovementioned type (including the safety gate monitoring module according to the disclosure), an actuator and a control unit.

It is self-evident that the features mentioned above and those yet to be explained below can be used not only in the respectively specified combination but also in other combinations or in isolation without departing from the spirit and scope of the present disclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of a safety gate having a safety gate monitoring module ac-cording to one example embodiment of the present disclosure.

FIG. 2A is a front view of the safety gate shown in FIG. 2A.

FIG. 2B is a front view of the safety gate shown in FIG. 2A.

FIG. 2C is a side view of the safety gate shown in FIG. 2A and FIG. 2B.

FIG. 3 is an exploded view of a safety gate monitoring module according to one example embodiment of the present disclosure.

FIG. 4 is a perspective view of the safety gate monitoring module shown in FIG. 3.

FIG. 5 is a perspective view of the safety gate monitoring module shown in FIGS. 3 and 4 to schematically illustrate a movement of a mounting bracket.

FIG. 6A is a perspective view of the safety gate monitoring module shown in FIGS. 3-5 with the mounting bracket in the first position.

FIG. 6B is a perspective view of the safety gate monitoring module shown in FIGS. 3-5 with the mounting bracket in the second position.

FIG. 6C is a perspective view of the safety gate monitoring module shown in FIGS. 3-5 with the mounting bracket in the third position.

FIG. 7 is a perspective view of a mounting bracket according to one example embodiment of the present disclosure.

FIG. 8A is a perspective view of a first interface according to one example embodiment of the present disclosure arranged on the safety gate monitoring module.

FIG. 8B is a perspective view of the first interface according to one alternative example embodiment of the present disclosure arranged on the safety gate monitoring module.

FIG. 9 is a sectional view of the safety gate monitoring module shown in FIGS. 3-5.

FIG. 10 is a perspective view of a plug according to one example embodiment of the present disclosure.

FIG. 11 is an exploded view of the mounting bracket and the plug according to one example embodiment of the present disclosure.

FIG. 12A is a perspective view of the mounting bracket according to a further example embodiment of the present disclosure.

FIG. 12B is a perspective view of the mounting bracket according to yet another example embodiment of the present disclosure.

In the drawings, reference numbers may be reused to identify similar and/or identical elements.

### DETAILED DESCRIPTION

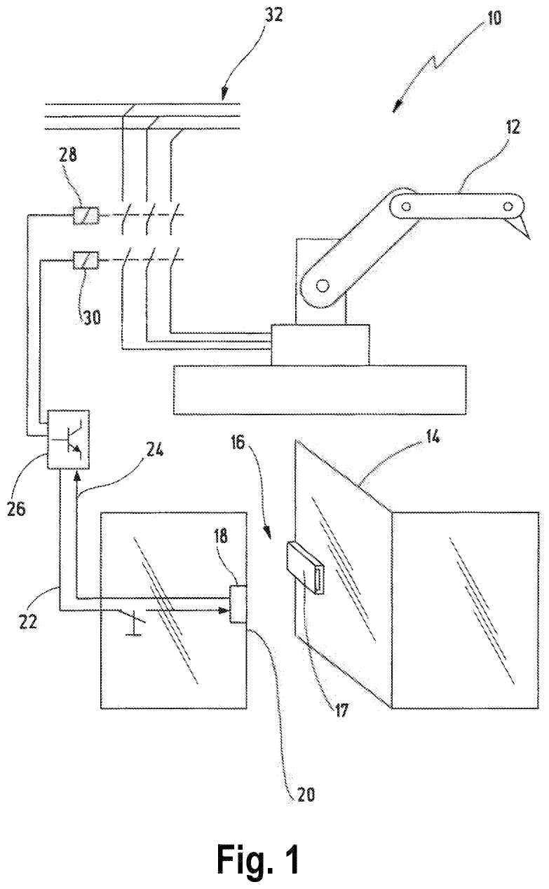

FIG. 1 shows a schematic view of one example embodiment of a safety gate monitoring system according to the disclosure. In the figure, the safety gate monitoring system is designated overall by the reference numeral 10.

Here, the safety gate monitoring system 10 includes a robot 12, the working area of which is safeguarded with the aid of a safety gate 14. A safety gate monitoring module 16 according to the present disclosure is arranged on the safety gate 14. The safety gate monitoring module 16 includes a door part 17, which is arranged on the movable door element (door leaf) of the safety gate 14, and a frame part 18, which is arranged on an immovable second part 20 of the safety gate 14. In the example embodiment illustrated, the immovable second part 20 of the safety gate 14 is a door frame or a door case. In other example embodiments, this second immovable part 20 of the safety gate 14 can also be a second door leaf of a two-part safety gate.

The frame part 18 of the safety gate monitoring module 16 is connected to a safety switching device 26 via two lines 22, 24. The safety switching device 26 is, for example, a safety switching device from the PNOZ<®>series, which is marketed by the applicant of the present disclosure. This is a multichannel redundant safety switching device, which is configured to evaluate the output signals of signalling devices, such as the safety gate monitoring module 16, and to switch off an electrical load in accordance therewith. In this case, the electrical load is the robot 12. Accordingly, the safety switching device 26 actuates two contactors 28, 30, the make contacts of which are arranged in the connection between a power supply 32 and the robot 12.

As an alternative to the safety switching device 26, the safety gate monitoring module 16 could also be connected to a programmable safety controller, such as that marketed by the applicant of the present disclosure under the designation PS S<®>. The safety switching device 26 is therefore generally referred to below as the control unit 26 of the safety gate monitoring system 10, without thereby being limited to a specific embodiment of this control unit. A number of example embodiments of the safety gate monitoring module 16 according to the disclosure are described below. Here, identical or equivalent components are denoted by the same reference signs.

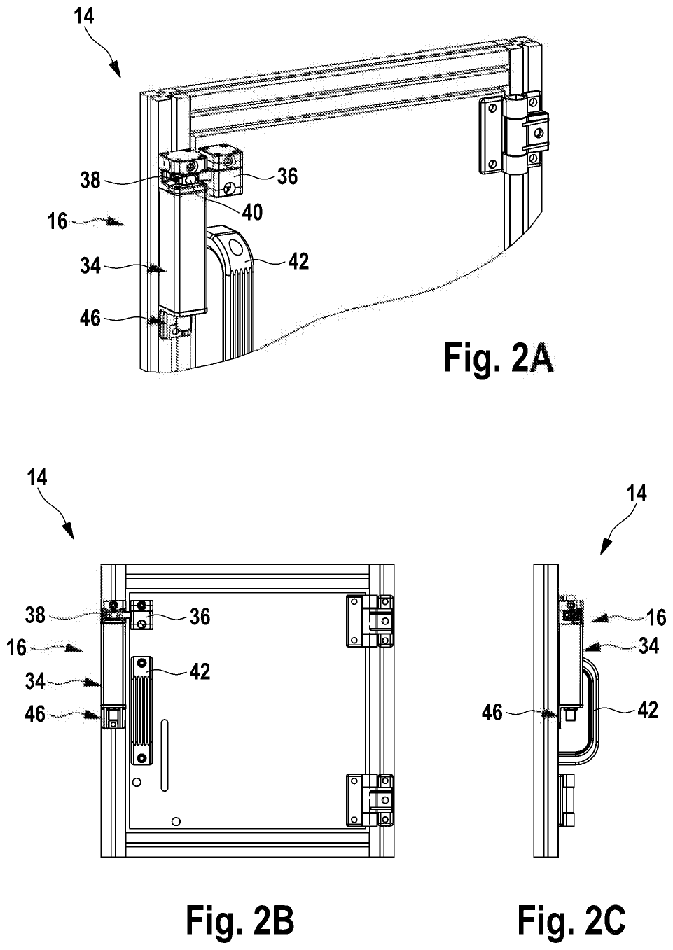

FIGS. 2A-2C show various views of an example embodiment of the safety gate 14 with the safety gate monitoring module 16 according to one example embodiment mounted thereon. FIG. 2A shows the safety gate 14 in a perspective view in a closed position. FIG. 2B shows the closed safety gate 14 in a front view and FIG. 2C shows the closed safety gate 14 in a side view.

The safety gate monitoring module 16 includes a base device 34 and an actuator 36, which interacts with the base device 34. The base device 34 may include one or more sensors and/or further electronic components and may therefore be connected to a power supply. Furthermore, the base device 34 may be connected to the control unit 26 via lines with multi-channel redundancy, such as the lines 22, 24 here. The base device 34 therefore may form the abovementioned frame part 18 of the safety gate monitoring module 16.

Although it would likewise be conceivable to use the base device 34 as a door part 17 of the safety gate monitoring module 16, this is less preferred. In such a case, the usually fixed wiring to the control unit 26 and the power supply would have to be routed to the movable part of the safety gate 14, and this is usually more complicated than feeding the lines 22, 24 and the power supply to the static part 20 of the safety gate 14.

The actuator 36 acts as a counterpart to the base device 34 and serves to actuate the base device 34. For this purpose, the base device 34 includes a corresponding actuator receptacle 38, into which the actuator 36 can be inserted (see FIGS. 2A-2C).

One function of the base device 34 is to detect whether the actuator 36 has been inserted into the actuator receptacle 38 or not. For this purpose, the actuator 36 may include an RFID chip, which can be read out by a detector arranged in the actuator receptacle 38. The base device 34 is configured to generate a safety gate signal when the actuator 36 is inserted into the actuator receptacle 38. This safety gate signal may be generated as an electrical signal. This can be a digital, a pulsed, a coded and/or other (preferably electrical) signal.

By evaluating the safety gate signal in the control unit 26, the safety gate monitoring system 10 can clearly determine at any time whether the safety gate 14 is closed or not. Depending on this, the robot 12 can be controlled in such a way that it can only be operated when the safety gate 14 is closed.

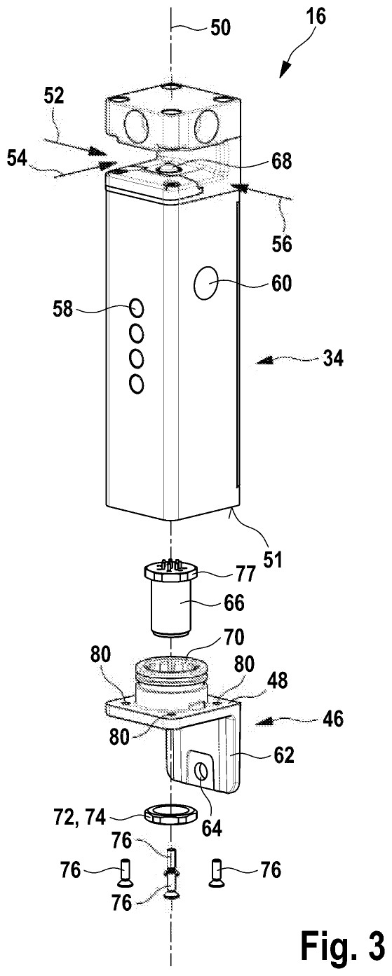

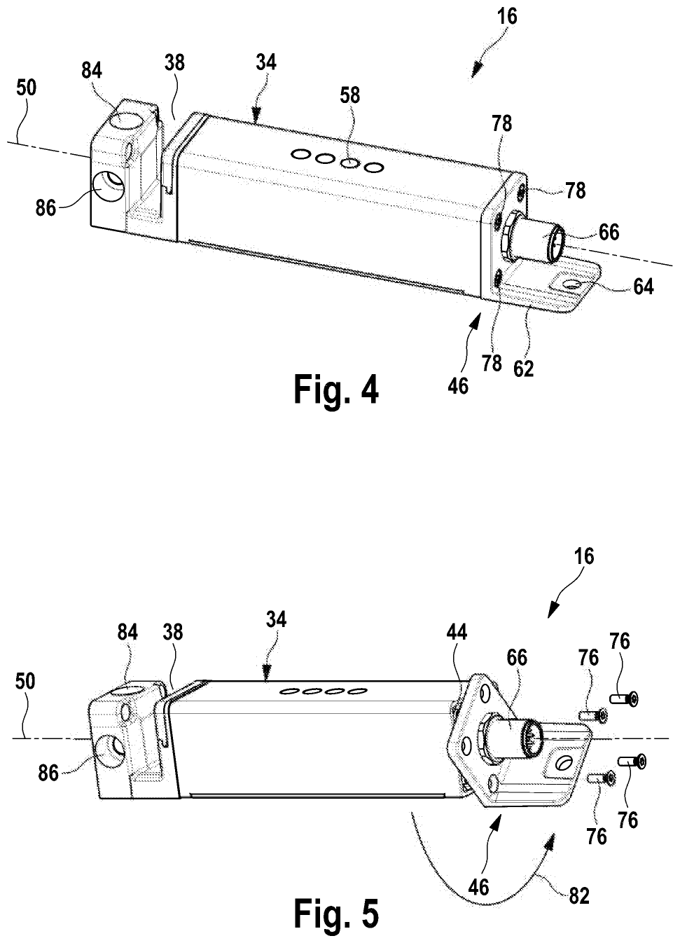

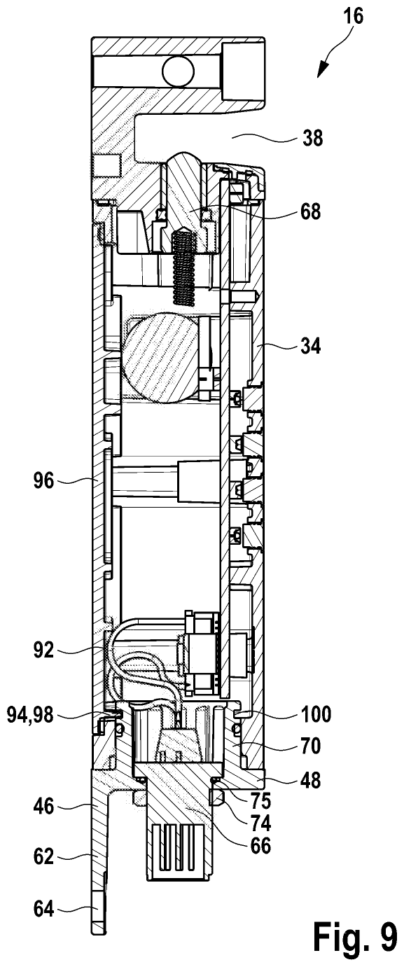

In the example embodiment shown in FIGS. 2A-2C, the actuator 36 includes a substantially rod/pin-shaped actuator element 40, which can be inserted into the actuator receptacle 38. On its end face inserted into the actuator receptacle 38, the actuator element 40 includes a through-hole (not shown) configured as a locating hole, into which a counter-holder 68, which is arranged in the actuator receptacle 38 and includes a bolt (see FIGS. 3 and 9), can engage in order to hold the actuator 36 in the actuator receptacle 38, for example during the activation of a guard lock function.

As shown in FIGS. 2A-2C, the actuator element 40 is inserted into the actuator receptacle 38 in the closed state of the safety gate 14. It goes without saying that the actuator receptacle 38 of the safety gate monitoring module 16 of the present disclosure is not intended to be restricted to receiving rod-/pin-shaped actuator elements 40, but is configured to receive actuators 36 in general which have an actuator element 40 that is suitable, in particular, with regard to shape.

In the example embodiment shown in FIGS. 2A-2C, the safety gate 14 includes a handle 42, by means of which a user can open or close the safety gate 14. Here, the safety gate 14 is configured as a pivoting door but in principle can also be configured as a sliding door or any other type of separating protective device (e.g. as a flap).

FIG. 3 shows an exploded view of the base device 34 with a mounting bracket 46, mountable thereon, of the safety gate monitoring module 16. The base device 34 extends along an axis 50, which here corresponds to a central or longitudinal axis of the base device 34. On a lower end face 51 (referred to here as the “first end face”) extending transversely to the axis 50, the base device 34 includes a first interface 44 (see also FIGS. 5, 8A, 8B), which interacts with a second interface 48 provided on the mounting bracket 46. The first interface 44 and the second interface 48 are configured to be coupled to one another.

The actuator receptacle 38 is configured to receive the actuator 36 from a first direction 52, from a second direction 54 rotated anticlockwise by 90° with respect to the first direction 52 about the axis 50, and from a third direction 56 rotated anticlockwise by 90° with respect to the second direction 54 about the axis 50. The actuator 36 can thus be inserted into the actuator receptacle 38 from at least three different directions 52, 54, 56. According to an embodiment, it allows the actuator 36 to be inserted into the actuator receptacle 38 from precisely these three different directions 52, 54, 56 (and no other direction). These three directions 52, 54, 56 all lie in a common plane.

In the example embodiment of the safety gate monitoring module 16 illustrated in FIG. 3, the actuator 36 can also be inserted into the actuator receptacle 38 from intermediate directions, which are rotated about the axis 50 by an angle <90° with respect to the directions 52, 54, 56 and are arranged in a common plane with the directions 52, 54, 56. The actuator 36 can be inserted into the actuator receptacle 38 with a rectilinear movement and/or a rotational movement.

The base device 34 furthermore includes one or more optical monitoring indicators 58, which indicate a state of the safety gate monitoring module 16. Furthermore, an operator control device 60 is provided, by means of which a user can change a state of the safety gate monitoring module 16, for example in order to block one or more functions of the safety gate monitoring module 16. For example, the operator control device 60 is configured for manual deactivation of the guard lock function of the safety gate monitoring module 16 by unlocking the counter-holder or blocking bolt 68.

In the example embodiment shown in FIG. 3, the mounting bracket 46 has a substantially L-shaped cross section. The mounting bracket 46 includes a mounting side 62, which is arranged transversely, particularly orthogonally, to the second interface 48 of the mounting bracket 46. On the mounting side 62, a fourth receptacle 64 is provided, which is configured to receive a fixing device, such as a screw, for fastening the mounting bracket 46 to, for example, the immovable second part 20 of the safety gate 14.

The mounting bracket 64 is further configured to receive a plug 66, which is connected to the base device 34 and can be part of the first interface 44. The mounting bracket 46 includes a first receptacle 70, which receives the plug 66. The plug 66 is configured to connect the base device 34 to a connection plug. With the help of the plug 66, the base device 34 of the safety gate monitoring module 16 can be connected, for example, to a power supply 32 and/or to the control unit 26.

The plug 66 is secured on the mounting bracket 46 axially along the axis 50 by means of an axial locking 72 (referred to here as a “second axial locking”). The axial locking 72 includes a nut 74 that can be screwed onto an external thread (not illustrated) provided on the plug 66. Furthermore, the axial locking 72 includes a counter-holder 75, arranged in the mounting bracket 46, for the head 77 of the plug 66 (see FIGS. 9 and 12A). In the assembled state, the plug 66 is thus axially secured in the first receptacle 70 of the mounting bracket 46, wherein the head 77 of the plug 66 is pressed against the counter-holder 75 in the axial direction with the aid of the nut 74 (see FIG. 9).

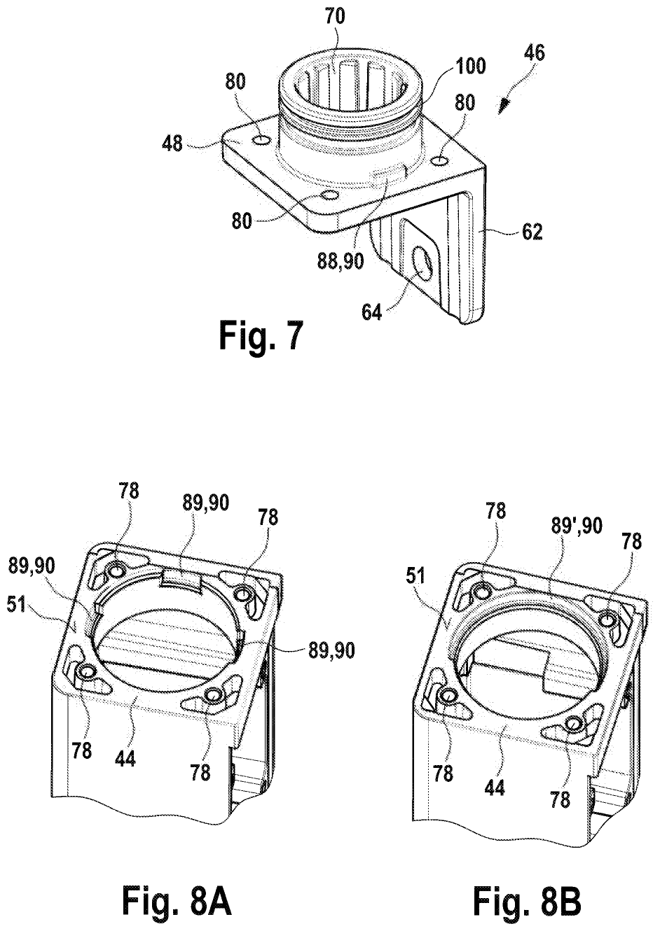

The mounting bracket 46 is fixed or fastened on the base device 34 by a plurality of fixing device 76. For this purpose, in the present case, the first interface 44 includes four receptacles 78 (referred to here as “second receptacles”) (see FIGS. 8A and 8B). The second interface 48 likewise includes four receptacles 80 (referred to here as “third receptacles”) (see FIGS. 7, 12A and 12B). The second receptacles 78 and the third receptacles 80 are configured to receive the fixing device 76, which may be embodied as screws. When the second receptacles 78 and the third receptacles 80 are aligned with one another, a second receptacle 78 and a third receptacle 80 can each jointly receive a fixing device 76 in order to fix or fasten the mounting bracket 46 on the base device 34. In the example embodiment shown here, the second receptacles 78 and the third receptacles 80 are each configured as through-holes, which together form a square hole pattern. In other words, the central axes of the through-holes forming the receptacles 78, 80 are arranged on corner points of a square in plan view.

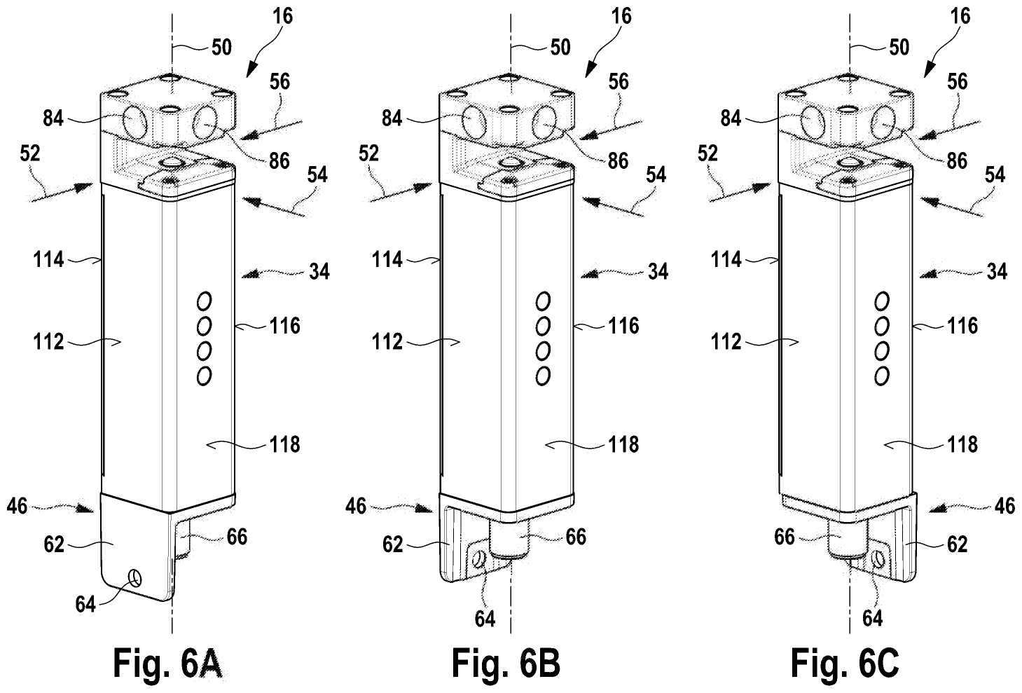

According to the disclosure, the mounting bracket 46 can be fixed or fastened in various positions on the base device 34. This makes it possible to fix or fasten the base device 34 in different alignments relative to the immovable second part 20 of the safety gate 14. The mounting bracket 46 can be coupled to the base device 34 in a first position (see FIG. 6A), a second position (see FIG. 6B), and a third position (see FIG. 6C). FIG. 5 schematically indicates, by means of the arrow 82, a direction of rotation in which the mounting bracket 46 can be pivoted about the axis 50 with respect to the base device 34. Of course, the mounting bracket 46 can only be pivoted with respect to the base device 34 when the fixing device 76 are undone.

FIG. 6A shows the mounting bracket 46 in its first position with respect to the base device 34. FIG. 6B shows the mounting bracket 46 in its second position with respect to the base device 34. FIG. 6C shows the mounting bracket 46 in its third position with respect to the base device 34. The second position is rotated 90° clockwise about the axis 50 of the base device 34 with respect to the first position. The third position is rotated 90° clockwise about the axis 50 of the base device 34 with respect to the second position.

Coupling of the first interface 44 to the second interface 48 in a fourth position rotated clockwise by 90° about the axis 50 of the base device 34 with respect to the third position is prevented by a mechanical blocking device 90 (see FIG. 7, FIG. 8A and FIG. 8B) in order to avoid incorrect assembly, as explained in detail below. Thus, the mounting bracket 46 can be arranged in exactly three different, predefined positions with respect to the base device 34. The fourth position can be a position that is unfavorable for the actuator receptacle 38 as regards reception of the actuator 36 since the actuator 36 cannot engage in the actuator receptacle 38, or can engage only with difficulty.

When the mounting bracket 46 is fixed or fastened in its first position on the base device 34, the mounting side 62 of the mounting bracket 46 is aligned orthogonally to the first direction 52 (FIG. 6A). If, on the other hand, the mounting bracket 46 is fixed or fastened in its second position on the base device 34, the mounting side 62 of the mounting bracket 46 is aligned orthogonally to the second direction 54 (FIG. 6B). In the third position, the mounting side 62 of the mounting bracket 46 is aligned orthogonally to the third direction 56 (FIG. 6C).

In the region of its upper end, the base device 34 furthermore includes a first through-hole 84 and a second through-hole 86 extending to the first through-hole 84. In the first position of the mounting bracket 46, the first through-hole 84 extends orthogonally to the mounting side 62 (FIG. 6A), in the second position the second through-hole 86 extends orthogonally to the mounting side 62 (FIG. 6B), and in the third position the first through-hole 84 extends orthogonally to the mounting side 62 (FIG. 6C).

Thus, the base device 34 can be fixed or fastened on the immovable second part 20 of the safety gate 14 using a fixing device (e.g. a screw) inserted into the first through-hole 84 if the first position, shown in FIG. 6A, of the mounting bracket 46 is selected. The through-hole 84 then extends parallel to the fourth receptacle 64 which is provided on the mounting bracket 46 and is used to fix or fasten the mounting bracket 46 on the immovable second part 20 of the safety gate 14 with the aid of a further fixing device (e.g. a screw).

In the second position, shown in FIG. 6B, of the mounting bracket 46, the second through-hole 86 extends parallel to the fourth receptacle 64, and therefore the base device 34, together with the mounting bracket 46, can then be fixed or fastened on the immovable second part 20 of the safety gate 14 by passing a fixing device through the second through-hole 86 and a further fixing device through the fourth receptacle 64.

Similarly, when the third position, shown in FIG. 6C, of the mounting bracket 46 is selected, the base device 34 can be fixed or fastened, together with the mounting bracket 46, on the immovable second part 20 of the safety gate 14 by passing a fixing device through the second through-hole 84 and a further fixing device through the fourth receptacle 64.

The base device 34 includes a first side surface 112, a second side surface 114, a third side surface 116, and a fourth side surface 118. The first side surface 112 is arranged on the left side of the base device 34. The second side surface 114 is arranged on the rear side of the base device 34. The third side surface 116 is arranged on the right side of the base device 34. The fourth side surface 118 is arranged on the front side of the base device 34. The first side surface 112 extends parallel to the third side surface 116. The second side surface 114 extends parallel to the fourth side surface 118 and transversely to the first and third side surfaces 112, 116, respectively.

In the first position, the mounting side 62 of the mounting bracket 46 is aligned parallel to or flush with the first side surface 112 (FIG. 6A). In the second position, the mounting side 62 of the mounting bracket 46 is aligned parallel to or flush with the second side surface 114 (FIG. 6B). In the third position, the mounting side 62 of the mounting bracket 46 is aligned parallel to or flush with the third side surface 116 (FIG. 6C). As already mentioned, alignment of the mounting side 62 of the mounting bracket 46 parallel to or flush with the fourth side surface 118 is prevented according to the disclosure by the mechanical blocking device 90.

The mechanical blocking device 90 can be seen, in particular, in FIGS. 7, 8A and 8B. The mechanical blocking device 90 includes a blocking element 88, which is arranged on the second interface 48 on the mounting bracket 46, and at least one recess 89, which functions as a counterpart thereto and is arranged on the first interface 44 of the base device 34. The at least one recess 89, 89′ receives the mechanical blocking element 88 in the first position, the second position, and the third position of the mounting bracket 46, respectively. However, the mechanical blocking device 90 prevents coupling of the first interface 44 to the second interface 48 in the fourth position.

FIGS. 8A and 8B show two different example embodiments of the part of the mechanical blocking device 90 which is provided on the first interface 44 arranged on the base device 34. The recess shown in FIG. 8A includes three spatially separate recesses 89, which are configured to receive the mechanical blocking element 88 in each case in one of the first position, the second position or the third position. In order to rotate the mounting bracket 46 from the first position into the second position, for example, the mounting bracket 46 must be lifted off axially along the axis 50 of the base device 34 and can then be brought into another position by inserting the blocking element 88 attached to the mounting bracket 46 into one of the two other recesses 89.

In the example embodiment shown in FIG. 8B, the recess 89′ is configured as a recess that extends around the axis 50 of the base device 34 by less than 360°. This example embodiment of the recess 89′ has an advantage, in particular, that the mounting bracket 46 can be rotated in an infinitely variable manner from one position into another position without the mounting bracket 46 having to be lifted off axially along the axis 50 of the base device 34 for this purpose. A suitable position (the first position, the second position, or the third position) is indicated to a user by means of one of the plurality of second receptacles 78 and a plurality of third receptacles 80 aligned therewith. A user can thus rotate the mounting bracket 46 in an infinitely variable manner until the user recognizes a suitable position on the basis of the aligned second and third receptacles 78, 80.

The recess 89′ extending around the axis 50 of the base device 34 by less than 360° can also prevent complete rotation of the plug 66 about the axis 50 of the base device 34. This can also be advantageous, in particular, if the plug 66 is connected to the base device 34 via electrical lines 92 which are to be protected from being twisted multiple times (see FIG. 9).

An axial locking 94 (here referred to as a “first axial locking”), which is shown in FIG. 9 and locks the mounting bracket 46 on the base device 34 along the axis 50, can be particularly advantageous in combination with the recess 89′ extending around less than 360°. The first axial locking 94 includes a side wall 96 detachably arranged on the base device 34 and having a mechanical blocking element 98 (referred to here as a “second mechanical blocking element”) and a receptacle 100 (referred to here as a “fifth receptacle”) arranged on the mounting bracket 46. To mount the mounting bracket 46 on the base device 34, the side wall 96 can be detached from the housing of the base device 34. The mounting bracket 46 can then be inserted into the base device 34, for example together with the plug 66. The detachable side wall 96 can then be reattached to the base device 34 such that the second mechanical blocking element 98 arranged on the side wall 96 engages in the receptacle 100 of the mounting bracket 46 and secures the mounting bracket 46 along the axis 50 of the base device 34. If the position of the mounting bracket 46 is then to be changed, this can be done by simply releasing the fixing device 76 and subsequently rotating the mounting bracket 46 about the axis 50. During the rotation, the mounting bracket 46 remains in its axially secured position. Damage to or even breakage of the electrical lines 92 can thereby be prevented in an effective manner.

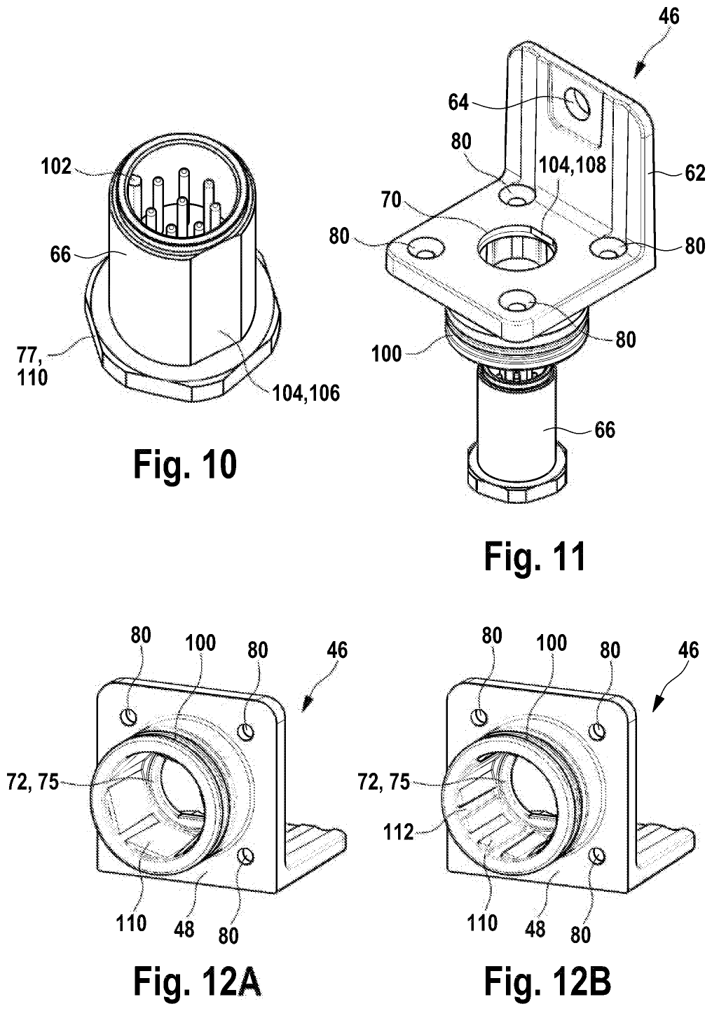

FIG. 10 shows a perspective view of an example embodiment of the plug 66. The plug 66 can have a poka-yoke element 102, which is configured to connect the plug 66 to a connection plug (e.g. for connection to the power supply 32 and/or the control unit 26) in only one specific orientation. This poka-yoke element 102 is often also referred to as the coding of the plug 66.

In a manner similar to a poka-yoke element, a positioning device 104 provided on the plug 66 and the first receptacle 70 of the mounting bracket 46 ensures that the first receptacle 70 can receive the plug 66 in only one specific orientation. In the example embodiment shown in FIG. 10 and FIG. 11, the plug 66 is of substantially cylindrical configuration and includes a flattened cylinder lateral surface 106, which in the assembled state rests against a planar stop surface 108 provided on the mounting bracket 46. Thus, the positioning device 104 is formed by the flattened cylinder lateral surface 106 and the stop surface 108.

FIG. 12A and FIG. 12B show two example embodiments of the mounting bracket 46. The essential difference between these two example embodiments consists in the way in which the first receptacle 70 is configured to form an anti-rotation lock 110, which prevents the plug 66 from rotating relative to the mounting bracket 46. In both cases, the first receptacle 70 of the mounting bracket 46 includes an inner contour corresponding to the outer contour of the plug head 77, ensuring that the plug 66 is secured rotationally about the axis 50 of the base device 34. In the example embodiment shown in FIG. 12A, the first receptacle 70 has a hexagonal inner contour formed from six sub-areas. In the example embodiment shown in FIG. 12B, the individual sub-areas are each additionally divided by a recess 112 into two sub-sub-areas.

It is self-evident that the example embodiments shown in the figures show only illustrative embodiments of the safety gate monitoring module 16 according to the disclosure, which are intended to illustrate advantages of the safety gate monitoring module 16 according to the disclosure. Various modifications can be made to these example embodiments without departing from the scope of the present disclosure.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

### LIST OF REFERENCE SIGNS

10 safety gate monitoring system
12 robot
14 safety gate
16 safety gate monitoring module
17 door part
18 frame part
20 immovable part
22, 24 lines
26 control unit
28, 30 contactors
32 power supply
34 base device
36 actuator
38 actuator receptacle
40 actuator element
42 handle
44 first interface
46 mounting bracket
48 second interface
50 axis
51 first end face
52 first direction
54 second direction
56 third direction
58 monitoring indicators
60 operator control device
62 mounting side
64 fourth receptacle
66 plug
68 counter-holder
70 first receptacle
72 second axial locking
74 nut
75 counter-holder
76 fixing device
77 head
78 second receptacles
80 third receptacles
82 direction of rotation
84 first through-hole
86 second through-hole
88 first mechanical blocking element
89, 89′ recess
90 mechanical blocking device
92 lines
94 first axial locking
96 side wall
98 second mechanical blocking element
100 fifth receptacle
102 poka-yoke element
104 positioning device
106 flattened cylinder lateral surface
108 stop surface
110 anti-rotation lock
112 first side surface
114 second side surface
116 third side surface
118 fourth side surface

1. A safety gate monitoring module configured to monitor a state of a safety gate, the safety gate monitoring module comprising:
a base device that:
is configured to generate a safety gate signal,
includes an actuator receptacle that is configured to receive an actuator,
is configured to generate the safety gate signal in response to the actuator being inserted into the actuator receptacle,
includes an axis and a first end face arranged transversely to the axis, and
includes a first interface; and
a mounting bracket including a second interface that is configured to be coupled to the first interface in:
a first position,
a second position rotated clockwise by 90° with respect to the first position about the axis, and
a third position rotated clockwise by 90° with respect to the second position about the axis,
wherein the first interface and the second interface include a mechanical blocking device that is configured to prevent coupling of the first interface to the second interface in a fourth position rotated clockwise by 90° with respect to the third position about the axis.

2. The safety gate monitoring module of claim 1 wherein:
the mounting bracket includes a mounting side that is arranged transversely to the second interface of the mounting bracket;
the actuator receptacle is configured to receive an actuator in:
a first direction,
a second direction rotated anticlockwise by 90° with respect to the first direction about the axis, and
a third direction rotated anticlockwise by 90° with respect to the second direction about the axis;
the mounting side is orthogonal to the first direction in the first position;
the mounting side is orthogonal to the second direction in the second position; and
the mounting side is orthogonal to the third direction in the third position.

3. The safety gate monitoring module of claim 1 wherein:
the mechanical blocking device includes a mechanical blocking element and a recess;
one of the first interface or the second interface includes the mechanical blocking element;
an other one of the first interface or the second interface includes the recess; and
the recess is configured to receive the mechanical blocking element in each of the first position, the second position, and the third position and to prevent the fourth position.

4. The safety gate monitoring module of claim 3 wherein the recess extends around the axis by less than 360°.

5. The safety gate monitoring module of claim 1 wherein the base device and/or the mounting bracket include a first axial locking that axially locks the mounting bracket along the axis.

6. The safety gate monitoring module of claim 5 wherein the base device includes a detachably fixed side wall that includes a part of the first axial locking.

7. The safety gate monitoring module of claim 1 wherein:
the mounting bracket includes a mounting side that is arranged transversely to the second interface of the mounting bracket,
the base device includes a first through-hole and a second through-hole, the second through-hole extending orthogonally to the first through-hole, and
the first through-hole extends orthogonally to the mounting side in the first position and the third position, and the second through-hole extends orthogonally to the mounting side in the second position.

8. The safety gate monitoring module of claim 1 wherein:
the mounting bracket includes a mounting side that is arranged transversely to the second interface of the mounting bracket,
the base device includes a first side surface, a second side surface and a third side surface that are arranged substantially transversely to the first end face, and
the mounting side of the mounting bracket is flush with or parallel to:
the first side surface in the first position,
the second side surface in the second position, and
the third side surface in the third position.

9. The safety gate monitoring module of claim 1 wherein:
the first interface includes a plug that is configured to transmit current and/or electrical signals, and
the second interface includes a first receptacle configured to receive the plug.

10. The safety gate monitoring module of claim 9 wherein at least one of the plug and the mounting bracket include an anti-rotation lock that rotationally locks the plug with respect to the axis in the first receptacle.

11. The safety gate monitoring module of claim 9 wherein at least one of the plug and the mounting bracket include a second axial locking that axially secures the plug in the first receptacle along the axis.

12. The safety gate monitoring module of claim 1 wherein:
the first interface includes a plurality of second receptacles,
the second interface includes a plurality of third receptacles,
at least one of the plurality of third receptacles is aligned with one of the plurality of second receptacles of the first interface in the first position, the second position, and the third position, and
the plurality of second receptacles and the plurality of third receptacles are each configured to receive a fixing device configured to couple the first interface to the second interface.

13. The safety gate monitoring module of claim 1 wherein:
the mounting bracket includes a mounting side that is arranged transversely to the second interface of the mounting bracket, and
the mounting side of the mounting bracket includes a fourth receptacle configured to receive a fixing device for fixing the mounting bracket to a mounting surface.

14. The safety gate monitoring module of claim 9 wherein the plug includes a poka-yoke element.

15. A safety gate monitoring system, comprising:
the safety gate monitoring module of claim 1;
the safety gate, wherein the safety gate controls access to a safety area;
an actuator; and
a control system configured to:
read the safety gate signal, and
control a machine or system located in the safety area in accordance with the safety gate signal.
